(19) United States
(12) Patent Application Publication
(10) Pub. No.: US 2009/0278484 A1
(43) Pub. Date: Nov. 12, 2009

(54) FAN CONDUCTED NOISE REDUCTION

(75) Inventors: Rajesh M. Nair, Nashua, NH (US); Peter Goryachev, Dublin, NH (US)

Correspondence Address: SCHWEGMAN, LUNDBERG & WOESSNER, P.A., P.O. BOX 2938, MINNEAPOLIS, MN, 55402, US

(73) Assignee: Degree Controls, Inc., Milford, NH (US)

(21) Appl. No.: 12/463,158

(22) Filed: May 8, 2009

Related U.S. Application Data
(60) Provisional application No. 61/051,937, filed on May 9, 2008.

(51) Int. Cl. H02P 6/04; H02P 27/00

(52) U.S. Cl. 318/400.25; 318/400.3

(57) ABSTRACT

A power circuit has an input circuit for coupling to a power supply to receive input current. One or more fans are driven with current pulses from an output circuit. Commutation noise from the current pulses back to the power supply is minimized. The commutation noise may be minimized by providing an isolated current source, by staggering the phase of pulses to multiple motors to increase the frequency and filter out the commutation noise, or by a combination thereof.

### RELATED APPLICATION

This application claims priority to U.S. Provisional Application Ser. No. 61/051,937, filed May 9, 2008, and entitled “FAN CONDUCTED NOISE REDUCTION,” which is incorporated herein by reference in its entirety.

### BACKGROUND

Fans for cooling electrical equipment typically operate on DC voltage. The DC fans consume current in pulses proportional to the speed of the fan. The pulses of current are generally seen at fairly low frequencies, such as in the 50 to 500 hertz range in some cases. The pulses of current generate conducted electrical noise that can interfere with electrical equipment circuitry. With increased circuit density in electrical equipment, more and more heat is generated, resulting in the need for increased airflow. To increase the airflow from fans, even higher current pulses are used, further increasing the amount of conducted electrical noise generated by the fans.

LC filters can be used to filter the conducted noise to reduce the amount of noise fed back to a power supply. Due to high current levels and relatively low frequency of noise generated, larger filters are used to reduce the noise seen by the electrical equipment. New ways are needed to reduce conducted noise fed back to power supplies resulting from driving fans. In many electronic equipment devices, fans may be the only devices that generate low frequency conducted noise.

### BRIEF DESCRIPTION OF THE DRAWINGS

FIG. 1 is a block diagram illustrating a fan controller driving multiple fans according to an example embodiment.

FIG. 2 is a block diagram illustrating further detail regarding the a fan control system for reducing variations in input current from a power supply according to an example embodiment.

FIG. 3 is a block diagram illustrating a fan control system utilizing a capacitor to reduce conductive noise according to an example embodiment.

FIG. 4 is a block diagram illustrating a fan control system driving multiple fans and reducing variations in input current from a power supply according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

As circuit density in electronics has increased, so has the need for additional airflow to cool such electronics. In just a few years, five to ten times more powerful fans are being used to cool electronics. Such fans generally consume length limited pulses of current at frequency ranges similar to the audible range of frequencies, such as 50-500 Hz. The pulses of current are currently in the 20 Amp range at approximately 48 volts. These parameters are shown merely for example, and the parameters of various fans may vary significantly. In any event, it is difficult to reduce the electrical motor commutation noise generated at such low frequencies, as LC filters tend to get much larger and more expensive at lower frequencies. Several embodiments are described that operate to reduce the amount of noise conducted back into power supplies from the fans, and also may increase the frequency of the noise, allowing smaller LC filters to be used to reduce the noise so conducted. The embodiments may be separately used, or combined in further embodiments.

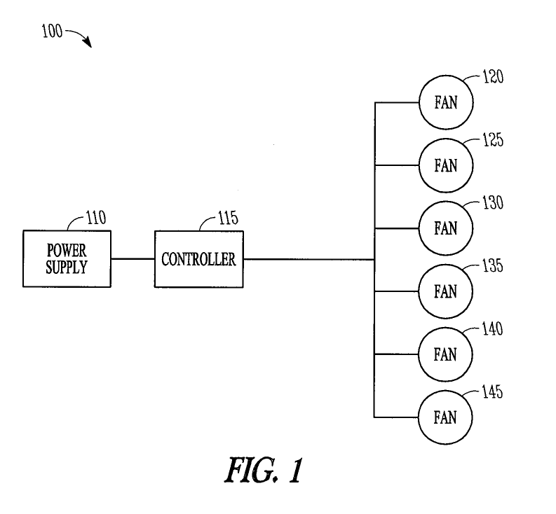

FIG. 1 is a block diagram of a system 100 that includes a power supply 110, a controller 115 and multiple fans 120, 125, 130, 135, 140 and 145 coupled to the controller 115. In one embodiment, the controller 115 provides control signals to the fans to cause the fans to operate at the same frequency and draw current pulses from the power supply in a phased manner. The phasing of the current pulses results in a higher frequency conducted noise back to the power supply than would result from a single fan drawing pulses of current. The controller may also include a filter to reduce the conducted noise. Since the frequency of the conducted noise is higher, the size of the filter may be smaller than previously required.

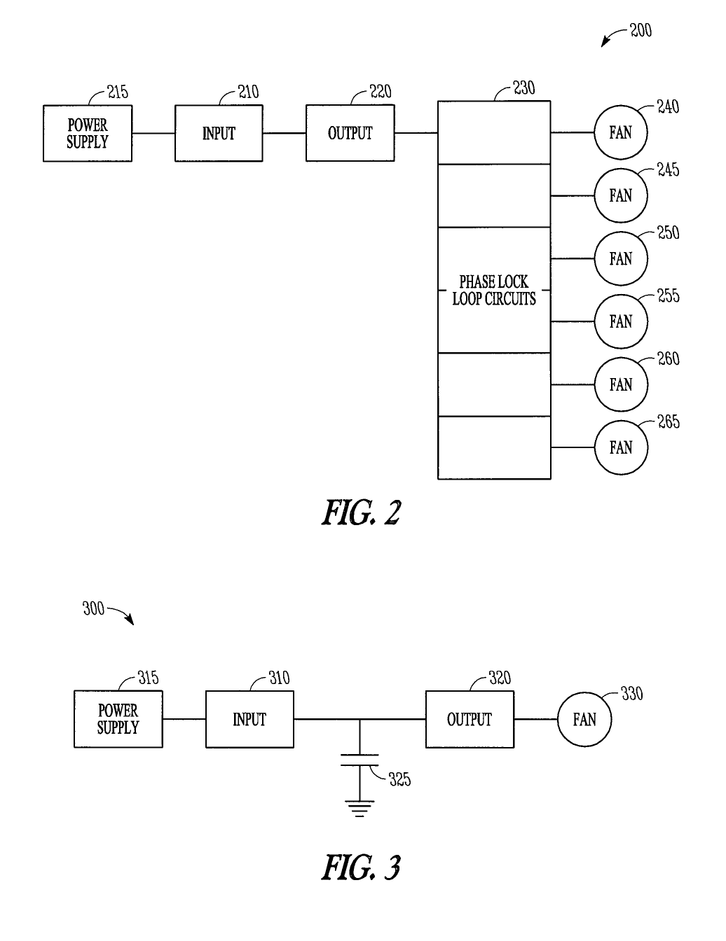

FIG. 2 is a block diagram illustrating a fan controller 200 driving multiple fans according to an example embodiment. In one embodiment, controller 200 has an input 210 to couple to a power supply 215 and receive current from the power supply 215. Controller 200 also has an output 220 to couple to the multiple fans and provide current pulses to run the multiple fans. In one embodiment, the output includes multiple phase lock loop circuits indicated at 230 to provide current pulses to the multiple fans 240, 245, 250, 255, 260, 265 at the same frequency and at staggered phases.

The frequency of conducted electrical noise generated from such current pulses that are staggered and phase lock looped is multiple times higher than would result from pulsing a single fan at the same frequency. In still further embodiments, the input 210 includes an LC filter 275 sized to reduce noise fed back to the power supply at the higher frequency. Since the effective conducted noise frequency is higher a conducted noise frequency resulting from pulsing a single fan, the physical size of the LC filter need not be as large, since the size needed to reduce noise is inversely proportional to the frequency of the noise. The higher frequency of the noise also result in the ability to reduce the cost of the LC filter.

In various embodiments, two, three or more fans may be operated with staggered pulses at the same frequency. In one embodiment, 6 or more fans may be so driven. In one embodiment, the different phases of the pulses are equally spaced over one cycle of pulsing the multiple fans.

In one embodiment, a method of controlling multiple fans includes driving a first fan with first limited length current pulses at a first frequency, driving a second fan with second limited length current pulses at the first frequency, and staggering the first and second limited length current pulses to increase an effective frequency of conducted noise resulting from driving the fans.

The method may further include driving one or more additional fans by additional current pulses at the first frequency, wherein all current pulses are staggered substantially equally to further increase the effective frequency of conducted noise resulting from driving the fans. In one embodiment, the different phases are equally spaced over one cycle of pulsing the multiple fans and the current pulses may be controlled by multiple phase lock loop circuits. Noise conducted back to a power supply may be filtered in some embodiments.

The phase lock loop function may also be implemented using electrical circuitry, or a combination of electrical circuits, micro processor and software.

FIG. 3 is a block diagram illustrating a fan control system 300 for reducing variations in input current from a power supply according to an example embodiment. In one embodiment, fan control system 300 is a power circuit that includes an input circuit 310 for coupling to a power supply 315 to receive input current. An output 320 is coupled to a capacitor 325, which provides current pulses to a fan 330. In one embodiment, capacitor 325 may be one or more capacitors electrically coupled to provide suitable current pulses to the fan 330. In one embodiment, input circuit 310 includes a filter that filters noise conducted from the fan 330 to the power supply 315 by restricting input current at the expense of offering output voltage that may swing wider. The input circuit 310 may be a current source that provides a constant current to the capacitor 325 regardless of voltage swings as pulses of current are provided to one or more fans. The fans are not adversely affected by such wider voltage swings. Output circuit 320 may include a switching circuit that drives the fan 330 with pulses of current from the capacitor. In one embodiment, the capacitor is integrated with the power circuit.

In a further embodiment, the input circuit 310 includes a linear FET that may be slowly turned on to control inrush current on start up of the fan 330. The slow turn on allows the capacitor 325 to charge to a sufficient level to start providing pulses to operate the fan 330. In one embodiment, the switching circuit provides pulses to the fan or fans from the capacitor. The pulses to multiple fans may be provided at the same time in one embodiment. The input current recharges the capacitor between the pulses and is fairly constant. Little if any noise from pulsing the fan or fans is provided back to the power supply 315. In one embodiment, the input circuit 310 may include a DC to DC converter for controlling voltage provided to the fan 330. In one embodiment, the capacitor is electrically isolated from the power supply by the DC to DC converter.

In one embodiment, the switching circuit is operable to couple to a power supply 315 and regulate current drawn from the power supply 315 to minimize variations in such current drawn from the power supply 315. The capacitor 325 may be a circuit coupled to the switching circuit to provide current pulses to run the cooling fan or fans 330. The capacitor 325 may be isolated from the power supply. In one embodiment, the switching circuit comprises a linear FET in series with the power supply. The FET may turn on slowly to reduce current spikes when the system begins operating. Many components of the fan system 300, such as capacitor 325 and circuit 320 may be repeated for multiple fans, and/or phase switched as above to further reduce conducted noise back to the power supply 315.

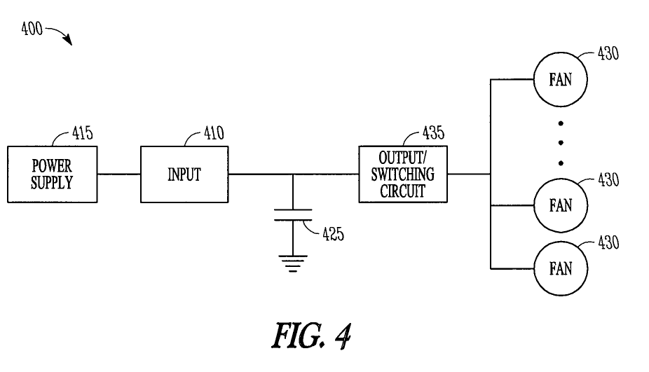

FIG. 4 is a block diagram illustrating a fan control system 400 driving multiple fans and reducing variations in input current from a power supply according to an example embodiment. Fan control system 400 may be in the form of a power circuit having an input circuit 410 for coupling to a power supply 415 to receive input current. An output 420 may be coupled to a capacitor 425 to provide a current source for multiple fans 430. The capacitor 425 may be one or more capacitors electrically coupled to provide a suitable source from which the fans may draw current pulses. A filter may be part of the input circuit 410 that filters noise conducted from the fans 430 back to the power supply 415. A switching circuit 435 controls the fans to consume pulses of current from the capacitor 425. The switching circuit 435 may be a phase switching circuit that staggers the limited length current pulses to the fans at the same frequency to increase an effective frequency of conducted noise resulting from driving the fans. The use of such phase switched current pulses may also reduce voltage swings in the capacitor by reducing spikes of current drawn from the capacitor. In one embodiment, the frequency of conducted noise generated from such current pulses is multiple times higher than would result from pulsing a single fan at the same frequency allowing the conducted noise to be more easily filtered such that it does not adversely affect other electronic devices coupled to the power supply 415. In a further embodiment, the different phases are equally spaced over one or more cycles of pulsing the multiple fans.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A power circuit comprising:
an input circuit for coupling to a power supply to receive input current;
an output for coupling to a capacitor to drive a fan;
a filter that filters noise conducted from the fan to the power supply; and
a switching circuit that drives the fan with pulses of current from the capacitor.

2. The power circuit of claim 1 wherein the capacitor is integrated with the power circuit.

3. The power circuit of claim 1 wherein the input circuit controls inrush current on start up of the fan.

4. The power circuit of claim 3 wherein the input circuit comprises a FET operable to turn on slowly while the capacitor charges.

5. The power circuit of claim 4 wherein the FET is a linear FET.

6. The power circuit of claim 1 wherein the switching circuit provides pulses to the fan from the capacitor as a function of the input current.

7. The power circuit of claim 1 and further comprising a DC to DC converter for controlling voltage provided to the fan.

8. The power circuit of claim 1 wherein the capacitor is electrically isolated from the power supply by the DC to DC converter.

9. A system comprising:
an input circuit to couple to a power supply and regulate current drawn from the power supply to minimize variations in such current drawn from the power supply;
a capacitor circuit coupled to the input circuit to receive current from the input circuit and provide current pulses to run a cooling fan, wherein the capacitor circuit is at least partially isolated from the power supply.

10. The system of claim 9 wherein the input circuit comprises a linear FET in series with the power supply.

11. The system of claim 10 wherein the FET turns on slowly to reduce current spikes when the system begins operating.

12. The system of claim 9 wherein the input circuit further comprising a DC to DC converter to isolate the capacitor circuit from the power supply.

13. A method comprising:
drawing a constant current from a power supply;
charging a capacitor with the constant current; and
providing pulses of current from the capacitor to one or more fans.

14. The method of claim 13 and further comprising isolating the capacitor from the power supply.

15. The method of claim 13 and further comprising phase shifting the pulses provided to the one or more fans to increase an effective frequency of conducted noise generated by providing pulses.

16. The method of claim 15 and further comprising filtering the conducted noise generated by providing pulses.

17. A controller for multiple fans, the controller comprising:
an input to couple to a power supply and receive current;
an output to couple to the multiple fans and provide current pulses to run the multiple fans; and
multiple phase lock loop circuits to provide current pulses to the multiple fans at the same frequency and at staggered phases.

18. The controller of claim 17 wherein a frequency of noise generated from such current pulses is multiple times higher than would result from pulsing a single fan at the same frequency.

19. The controller of claim 17 and further comprising an LC filter sized to reduce noise fed back to the power supply at the higher frequency.

20. The controller of claim 17 wherein the multiple fans comprise 6 or more fans.

21. The controller of claim 17 wherein the different phases are equally spaced over one cycle of pulsing the multiple fans.

22. A method of controlling multiple fans, the method comprising:
driving a first fan with first limited length current pulses at a first frequency;
driving a second fan with second limited length current pulses at the first frequency; and
staggering the first and second limited length current pulses to increase an effective frequency of conducted noise resulting from driving the fans.

23. The method of claim 22 and further comprising driving one or more additional fans by additional current pulses at the first frequency, wherein all current pulses are staggered substantially equally to further increase the effective frequency of conducted noise resulting from driving the fans.

24. The method of claim 23 wherein the different phases are equally spaced over one cycle of pulsing the multiple fans.

25. The method of claim 22 wherein the current pulses are provided by multiple phase lock loop circuits.

26. The method of claim 22 and further comprising filtering noise conducted back to a power supply.

27. A power circuit comprising:
an input circuit for coupling to a power supply to receive input current;
an output for coupling to a capacitor to drive multiple fans;
a filter that filters noise conducted from the fans to the power supply; and
a switching circuit that drives the fans with pulses of current from the capacitor, wherein the switching circuit staggers the limited length current pulses to the fans at the same frequency to increase an effective frequency of conducted noise resulting from driving the fans.

28. The power circuit of claim 27 wherein a frequency of conducted noise generated from such current pulses is multiple times higher than would result from pulsing a single fan at the same frequency.

29. The power circuit of claim 27 wherein the multiple fans comprise 6 or more fans.

30. The power circuit of claim 27 wherein the different phases are equally spaced over one cycle of pulsing the multiple fans.
